(19) United States
(12) Patent Application Publication
(10) Pub. No.: US 2016/0246109 A1
(43) Pub. Date: Aug. 25, 2016

(54) METHOD FOR MANUFACTURING ALIGNMENT MARK OF CF SUBSTRATE

(71) Applicant: SHENZHEN CHINA STAR OPTOELECTRONICS TECHNOLOGY CO., LTD., Shenzhen, Guangdong (CN)

(72) Inventor: Yuan XIONG, Shenzhen (CN)

(73) Assignee: Shenzhen China Star Optoelectronics Technology Co., Ltd., Shenzhen, Guangdong (CN)

(21) Appl. No.: 14/426,984

(22) PCT Filed: Sep. 16, 2014
(86) PCT No.: PCT/CN2014/086590

§ 371 Date: Mar. 9, 2015

(30) Foreign Application Priority Data
Aug. 26, 2014 (CN) 201410426173.X

(51) Int. Cl. G02F 1/1335; G02F 1/1362

(52) U.S. Cl. CPC G02F 1/133514; G02F 1/136209; G02F 2001/133354

(57) ABSTRACT

The present invention provides a method for manufacturing an alignment mark of a CF substrate, which includes step 1: providing a CF substrate (1); step 2: forming an organic material layer (2) on the CF substrate (1) and simultaneously forming a plurality of alignment marks (3) that is of the same material as the organic material layer (2) on an outer circumferential area of an effective displaying zone of the CF substrate (1) for alignment with respect to a TFT substrate; and step 3: subjecting the alignment marks (3) to a blackening treatment to enhance identifiability of the alignment marks (3) with detection with a CCD. The method improves the identifiability of the alignment marks with detection with a CCD so as to allow the alignment marks to serve as a clear alignment reference for the subsequent processes.

### BACKGROUND OF THE INVENTION

1. Field of the Invention

The present invention relates to the field of liquid crystal displaying technology, and in particular to a method for manufacturing an alignment mark of a color filter (CF) substrate.

2. The Related Arts

Liquid crystal displays (LCDs) have a variety of advantages, such as thin device body, low power consumption, and being free of radiation, and are thus of wide applications, such as liquid crystal televisions, mobile phones, personal digital assistants (PDAs), digital cameras, computer monitors, and notebook computer screens.

The liquid crystal displays generally comprise an enclosure, a liquid crystal display panel arranged in the enclosure, and a backlight module mounted in the enclosure. The structure of the liquid crystal display panel is generally composed of a thin-film transistor (TFT) array substrate, a color filter (CF) substrate, and a liquid crystal layer arranged between the two substrates and the principle of operation is that a driving voltage is applied to the two glass substrates to control rotation of the liquid crystal molecules of the liquid crystal layer in order to refract out light emitting from the backlight module for generating images.

As shown in FIG. 1, in the conventional structure of the liquid crystal display panel, the first process of manufacturing a CF substrate 100 is to form a black matrix (BM) 200. The black matrix 200 constitutes a light shielding structure for a pixel zone. Further, the first process also forms alignment marks 300 that is of the same material as the black matrix 200 on an outer circumference of the pixel zone to serve as a reference for alignment in assembling the CF substrate 100 with a TFT substrate.

With the advancing of the liquid crystal displaying technology, a series of new techniques emerges to help increase the aperture ratio of the liquid crystal display panel. BOA (BM on Array) that arranges the black matrix on the TFT substrate is one of these techniques.

The BOA technique, however, also suffers certain problems. As shown in FIG. 2, in a BOA architecture panel, the black matrix is formed on the TFT substrate. This makes only the structures of color resist, photo spacers (PS) 200′, and IT pixel electrode remain on the CF substrate that is on the opposite side so as to lack high optical density (OD) material. Since a charge coupled device (CCD) has poor capability in identifying the low optical density material, it is generally not possible to form alignment marks that are identical to those of a conventional architecture liquid crystal display panel on the CF substrate, making it impossible to provide a clear alignment reference for the subsequent processes.

### SUMMARY OF THE INVENTION

An object of the present invention is to provide a method for manufacturing an alignment mark of a color filter (CF) substrate, which improves the identifiability of the alignment with detection made with a charge coupled device (CCD) so as to allow the alignment mark to serve as a clear alignment reference for the subsequent processes.

To achieve the above object, the present invention provides a method for manufacturing an alignment mark of a color filter (CF) substrate, which comprises the following steps:

step 1: providing a CF substrate;

step 2: forming an organic material layer on the CF substrate and simultaneously forming a plurality of alignment marks that is of the same material as the organic material layer on an outer circumferential area of an effective displaying zone of the CF substrate for alignment with respect to a thin-film transistor (TFT) substrate; and

step 3: subjecting the alignment marks to a blackening treatment to enhance identifiability of the alignment marks with detection with a charge coupled device (CCD).

The CF substrate is a CF substrate of a black matrix on array (BOA) architecture liquid crystal display panel.

In step 2, the organic material layer is one of organic structure layers formed on the CF substrate.

In step 2, the organic material layer is a first layer of organic material formed on the CF substrate.

In step 2, the organic material layer is a photo spacer layer.

In step 3, the blacken treatment is carried out on the alignment marks by setting a location and a size of a processing zone for each of the alignment marks and applying an enhancing measure in a range of the processing zone.

The processing zones completely cover the alignment marks respectively and the processing zones have areas greater than areas of the alignment marks.

The locations and the sizes of the processing zones are finally determined with coordinate data supplied from a machine platform and correction of the coordinate data being performed with a photo mask. The sizes of the processing zones are determined collectively by positioning accuracy of the machine platform and accuracy of a yellow process of the organic material layer.

The enhancing measure is laser burning, ultraviolet light exposure, or carbonization.

The alignment marks are respectively set at intersections of two adjacent ones of edges of the CF substrate.

The efficacy of the present invention is that the present invention provides a method for manufacturing an alignment mark of a CF substrate, in which alignment marks of the same material as an organic material layer are formed on the CF substrate and the alignment marks are subjected to a blackening treatment to increase the optical density of the alignment marks and improve the identifiability of the alignment marks with detection with a CCD so as to allow the alignment marks to serve as a clear alignment reference for the subsequent processes.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view showing a color filter (CF) substrate of a conventional liquid crystal display panel;

FIG. 2 is a schematic view showing a CF substrate of a known BOA (BM on Array) color liquid crystal display panel;

FIG. 3 is a flow chart illustrating a method for manufacturing an alignment mark of a CF substrate according to the present invention;

FIG. 4 is a schematic view showing the second step of the method for manufacturing an alignment mark of a CF substrate according to the present invention; and

FIGS. 5-7 are schematic views showing the third step of the method for manufacturing an alignment mark of a CF substrate according to the present invention.

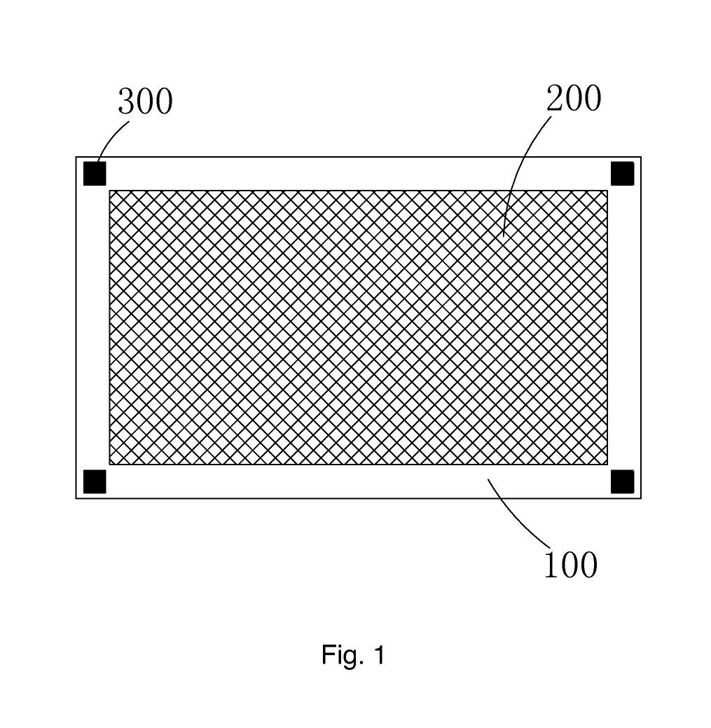

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

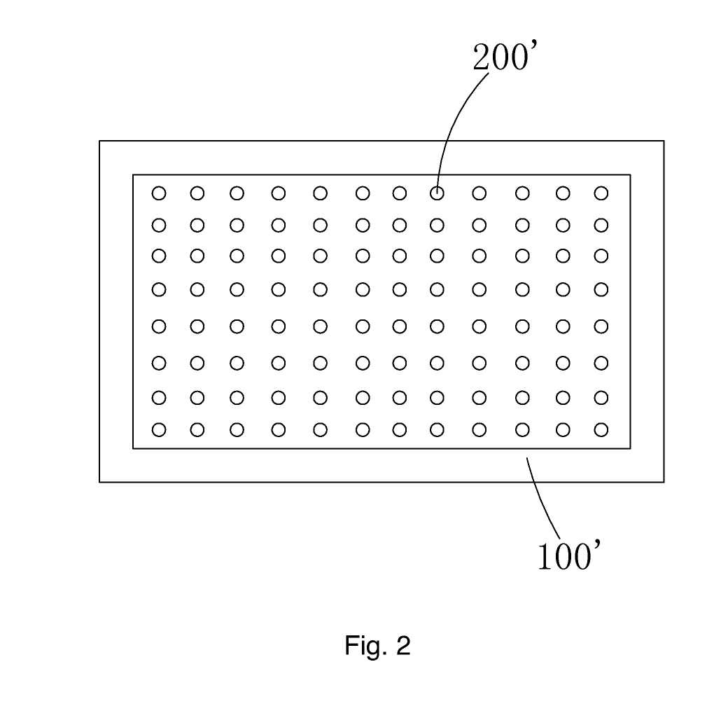

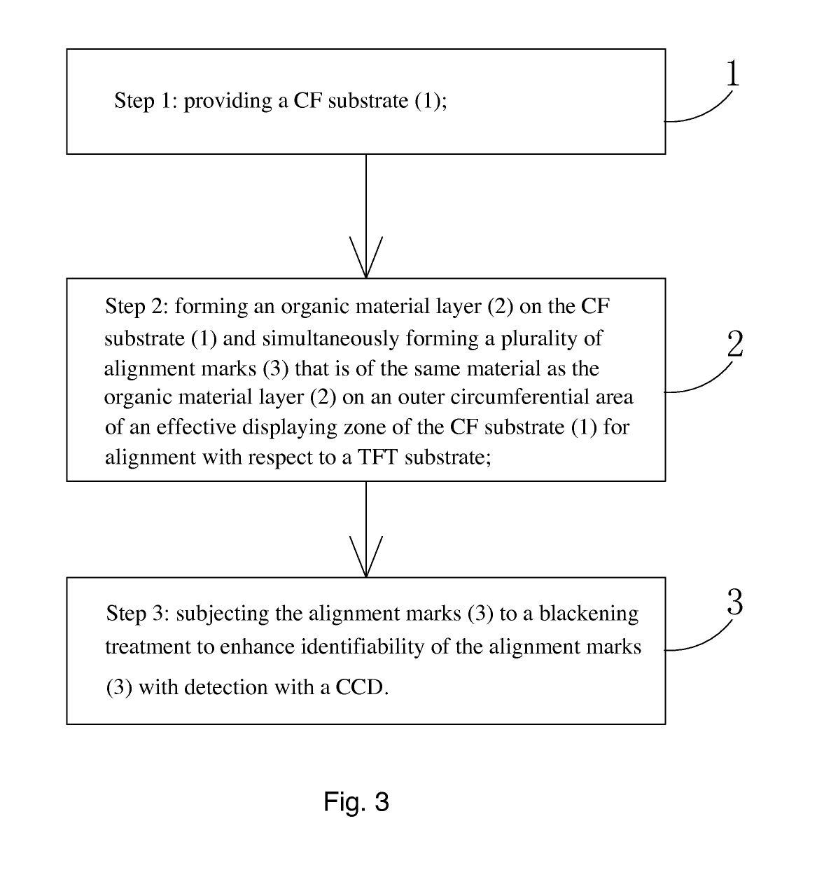

Referring to FIGS. 2-7, the present invention provides a method for manufacturing an alignment mark of a color filter (CF) substrate, which comprises the following steps:

Step 1: providing a CF substrate 1.

The CF substrate 1 is a CF substrate of a BOA (Black-Matrix on Array) architecture liquid crystal display panel. Since the BOA architecture liquid crystal display panel is structured by having a black matrix formed on a thin-film transistor (TFT) substrate, the CF substrate 1 of Step 1 does not include any high optical density material and does not have alignment marks that are identical to those of a conventional architecture liquid crystal display panel.

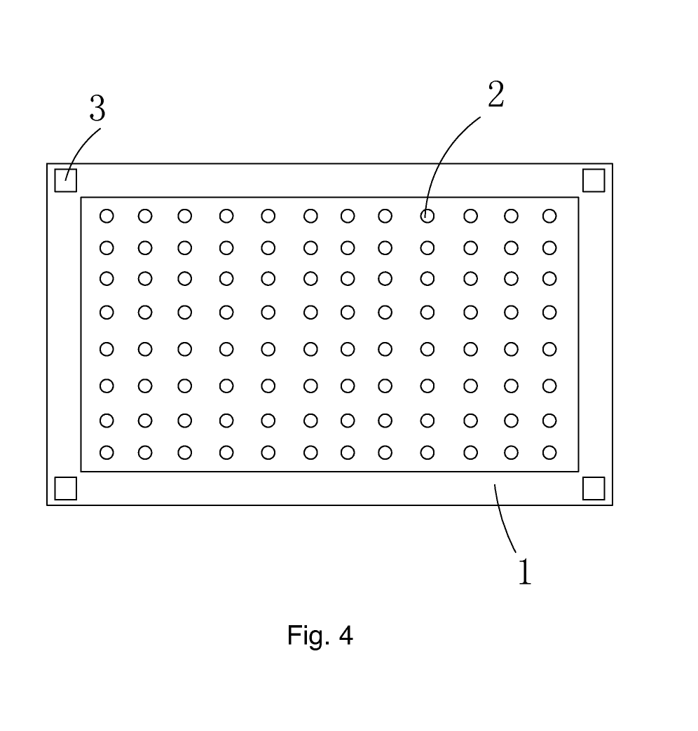

Step 2: as shown in FIG. 4, forming an organic material layer 2 on the CF substrate 1 and simultaneously forming a plurality of alignment marks 3 that is of the same material as the organic material layer 2 on an outer circumferential area of an effective displaying zone of the CF substrate 1.

Specifically, the organic material layer 2 can be any one of organic structure layers of the CF substrate 1, such as a photo spacer layer and a color resist layer and the same material that makes the organic material layer 2 is used to form the alignment marks 3. Further, to ensure the accuracy of the subsequent processes, the organic material layer 2 is selected as a first organic layer formed on the CF substrate 1. Preferably, the organic material layer 2 is a photo spacer layer.

The alignment marks 3 are respectively set on intersections of two adjacent edges of the CF substrate 1. Since the material of the alignment marks 3 is an organic material that is the same as that of the organic material layer 2, the optical density is extremely low and is hard to be identified with a charge coupled device (CCD), so that a blackening treatment is necessarily performed on the alignment marks in the subsequent steps.

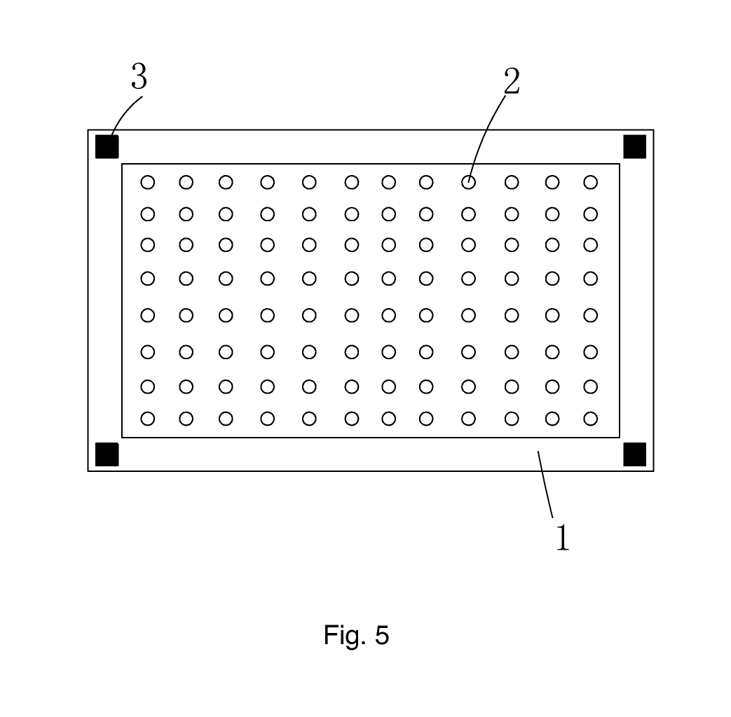

Step 3: referring collectively to FIGS. 5-7, subjecting the alignment marks 3 to a blackening treatment to enhance identifiability of the alignment marks 3 with detection with a CCD.

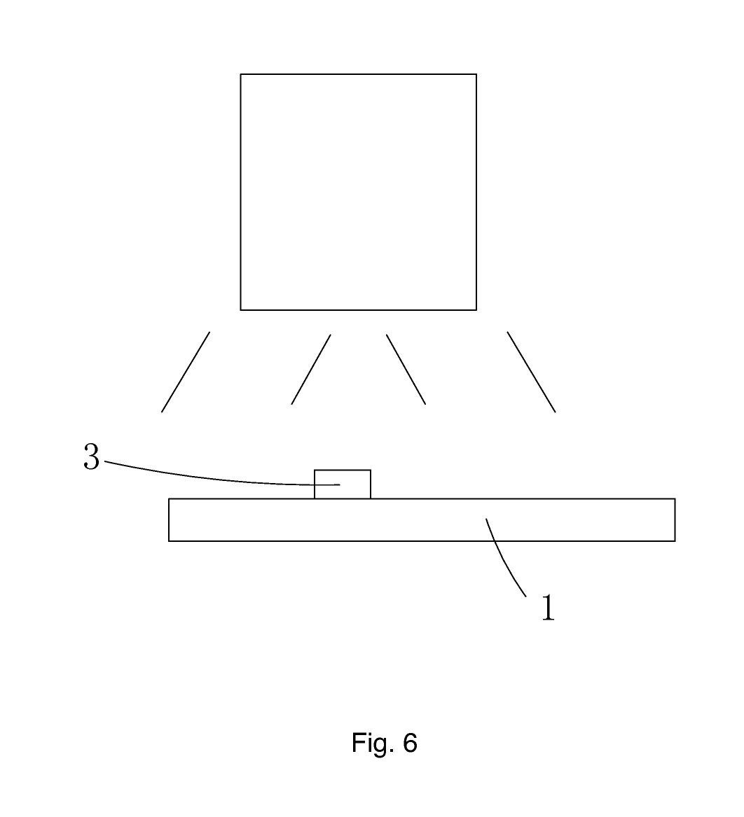

A specific process of Step 3 can be as follows: Firstly, a processing zone 4 is set for each of the alignment marks 3. Coordinate data are supplied through a machine platform. A photo mask is then applied for correction of the coordinate data in order to determine the final location and size of the processing zone 4. Then, as shown in FIG. 6, an enhancing measure, such as laser burning, ultraviolet light exposure, and carbonization, is applied within the range of the processing zone 4 to subject the alignment mark 3 to the blackening treatment for increasing the value of the optical density of the alignment mark 3 thereby improving the identifiability of the alignment marks 3 with the detection with a CCD to provide a clear alignment reference for the subsequent processes.

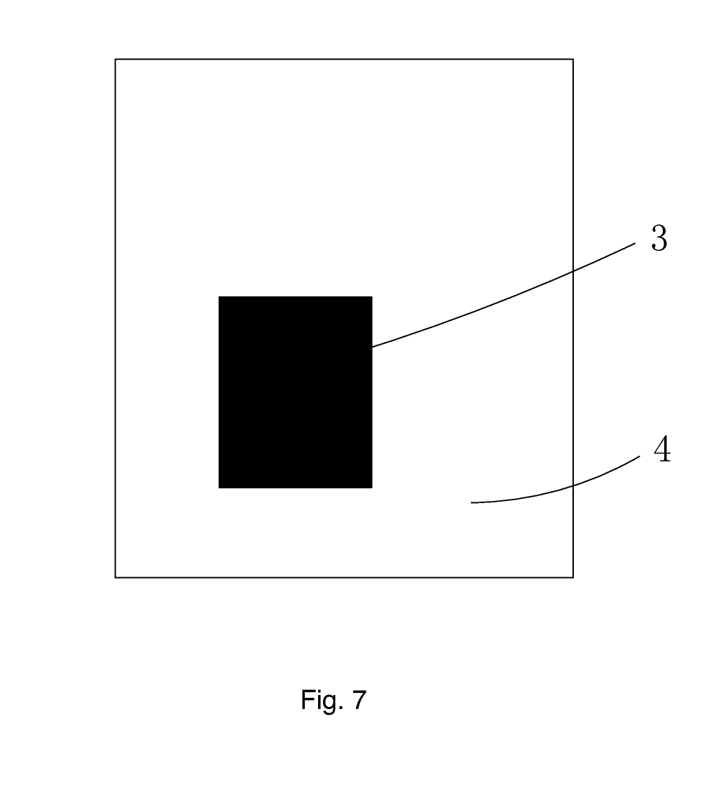

The size of the processing zone 4 is collectively determined by the positioning accuracy of the machine platform and the accuracy of a yellow light process of the organic material layer 2. As shown in FIG. 7, to have the alignment marks 3 entirely subjected to the blackening treatment, the processing zone 4 is set to completely cover the alignment mark 3 and the processing zone 4 has an area that is greater than the area of the alignment mark 3. It is noted here that in the performance of the blackening treatment, the alignment marks 3 are not necessarily located at the exact centers of the processing zones 4 and it only needs to ensure the alignment marks 3 are respectively located within the ranges of the processing zone 4 and completely covered by the processing zones 4 for the achievement of being completely blackened.

In summary, the present invention provides a method for manufacturing an alignment mark of a CF substrate, in which alignment marks of the same material as an organic material layer are formed on the CF substrate and the alignment marks are subjected to a blackening treatment to increase the optical density of the alignment marks and improve the identifiability of the alignment marks with detection with a CCD so as to allow the alignment marks to serve as a clear alignment reference for the subsequent processes.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for manufacturing an alignment mark of a color filter (CF) substrate, comprising the following steps:
step 1: providing a CF substrate;
step 2: forming an organic material layer on the CF substrate and simultaneously forming a plurality of alignment marks that is of the same material as the organic material layer on an outer circumferential area of an effective displaying zone of the CF substrate for alignment with respect to a thin-film transistor (TFT) substrate; and
step 3: subjecting the alignment marks to a blackening treatment to enhance identifiability of the alignment marks with detection with a charge coupled device (CCD).

2. The method for manufacturing an alignment mark of a CF substrate as claimed in claim 1, wherein the CF substrate is a CF substrate of a black matrix on array (BOA) architecture liquid crystal display panel.

3. The method for manufacturing an alignment mark of a CF substrate as claimed in claim 1, wherein in step 2, the organic material layer is one of organic structure layers formed on the CF substrate.

4. The method for manufacturing an alignment mark of a CF substrate as claimed in claim 3, wherein in step 2, the organic material layer is a first layer of organic material formed on the CF substrate.

5. The method for manufacturing an alignment mark of a CF substrate as claimed in claim 4, wherein in step 2, the organic material layer is a photo spacer layer.

6. The method for manufacturing an alignment mark of a CF substrate as claimed in claim 1, wherein in step 3, the blacken treatment is carried out on the alignment marks by setting a location and a size of a processing zone for each of the alignment marks and applying an enhancing measure in a range of the processing zone.

7. The method for manufacturing an alignment mark of a CF substrate as claimed in claim 6, wherein the processing zones completely cover the alignment marks respectively and the processing zones have areas greater than areas of the alignment marks.

8. The method for manufacturing an alignment mark of a CF substrate as claimed in claim 6, wherein the locations and the sizes of the processing zones are finally determined with coordinate data supplied from a machine platform and correction of the coordinate data being performed with a photo mask, the sizes of the processing zones being determined collectively by positioning accuracy of the machine platform and accuracy of a yellow process of the organic material layer.

9. The method for manufacturing an alignment mark of a CF substrate as claimed in claim 6, wherein the enhancing measure is laser burning, ultraviolet light exposure, or carbonization.

10. The method for manufacturing an alignment mark of a CF substrate as claimed in claim 1, wherein the alignment marks are respectively set at intersections of two adjacent ones of edges of the CF substrate.

11. A method for manufacturing an alignment mark of a color filter (CF) substrate, comprising the following steps:
step 1: providing a CF substrate;
step 2: forming an organic material layer on the CF substrate and simultaneously forming a plurality of alignment marks that is of the same material as the organic material layer on an outer circumferential area of an effective displaying zone of the CF substrate for alignment with respect to a thin-film transistor (TFT) substrate; and
step 3: subjecting the alignment marks to a blackening treatment to enhance identifiability of the alignment marks with detection with a charge coupled device (CCD);
wherein the CF substrate is a CF substrate of a black matrix on array (BOA) architecture liquid crystal display panel;
wherein in step 2, the organic material layer is one of organic structure layers formed on the CF substrate;
wherein in step 2, the organic material layer is a first layer of organic material formed on the CF substrate;
wherein in step 2, the organic material layer is a photo spacer layer;
wherein in step 3, the blacken treatment is carried out on the alignment marks by setting a location and a size of a processing zone for each of the alignment marks and applying an enhancing measure in a range of the processing zone;
wherein the processing zones completely cover the alignment marks respectively and the processing zones have areas greater than areas of the alignment marks;
wherein the locations and the sizes of the processing zones are finally determined with coordinate data supplied from a machine platform and correction of the coordinate data being performed with a photo mask, the sizes of the processing zones being determined collectively by positioning accuracy of the machine platform and accuracy of a yellow process of the organic material layer;
wherein the enhancing measure is laser burning, ultraviolet light exposure, or carbonization; and
wherein the alignment marks are respectively set at intersections of two adjacent ones of edges of the CF substrate.
